(19) United States
(12) Patent Application Publication
(10) Pub. No.: US 2003/0124265 A1
(43) Pub. Date: Jul. 3, 2003

(54) Method and materials for transferring a material onto a plasma treated surface according to a pattern

(75) Inventors: Erika Bellmann, St. Paul, MN (US); Padiyath Raghunath, Woodbury, MN (US); John P. Baetzold, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/004,706

(22) Filed: Dec. 4, 2001

(51) Int. Cl. H05H 1/00; B05D 5/06; B05D 5/12

(52) U.S. Cl. 427/536; 427/66; 427/68

(57) ABSTRACT

A method of transferring a transfer element of a donor sheet to a receptor includes forming an organic layer on a receptor substrate and forming a transfer element on a donor sheet, where the exposed surface of the transfer element is organic. Either the surface of the organic layer or the exposed surface of the transfer element (or both) is roughened using a plasma treatment. The transfer element of the donor sheet is then selectively thermally transferred to the surface of the organic layer.

### BACKGROUND

Pattern-wise thermal transfer of materials from donor sheets to receptor substrates has been proposed for a wide variety of applications. For example, materials can be selectively thermally transferred to form elements useful in electronic displays and other devices. Specifically, selective thermal transfer of color filters, black matrix, spacers, polarizers, conductive layers, transistors, phosphors, and organic electroluminescent materials have all been proposed. There is a need for materials and methods to facilitate, enhance, or otherwise assist the thermal transfer from donor sheets to receptor substrates.

### SUMMARY OF THE INVENTION

The present invention is directed to materials and methods for the selective thermal patterning of a transfer element on a receptor substrate and to article and devices made using these materials and methods. One embodiment is a method of transferring a transfer element of a donor sheet to a receptor. The method includes forming an organic layer on a receptor substrate and forming a transfer element on a donor sheet, where the exposed surface of the transfer element is also an organic material. Either the surface of the organic layer on the receptor substrate or the exposed surface of the transfer element (or both) is roughened using a plasma treatment. The transfer element of the donor sheet is then selectively thermally transferred to the surface of the organic layer. Preferably, the plasma treatment does not substantially chemically modify any treated surface or, alternatively, partial oxidation of the plasma-treated surface is the only chemical modification. However, in some embodiments, chemical modification may be desirable to reduce the receptiveness of a portion of the receptor to transfer. Suitable plasma treatments include, for example, RF plasmas of O₂, argon, and nitrogen or combinations thereof.

Another embodiment is a method of transferring a transfer element of a donor sheet to a receptor. The method includes forming an organic charge transfer layer on a receptor substrate; roughening a surface of the charge transfer layer using a plasma treatment; and selectively thermally transferring a transfer element of a donor sheet to the surface of the charge transfer layer after roughening the surface. The transfer element preferably has at least one light emitting layer. As an alternative to or in addition to roughening the surface of the charge transfer layer, the surface of the transfer layer of the donor sheet can be roughened using a plasma treatment.

Yet another embodiment is a method of making an electroluminescent device. The method includes forming an electrode on a receptor substrate; forming an organic charge transfer layer over the electrode; roughening a surface of the charge transfer layer using a plasma treatment; and selectively thermally transferring a transfer element of a donor sheet to the surface of the charge transfer layer after roughening the surface. The transfer element preferably has at least one light emitting layer. As an alternative to or in addition to roughening the surface of the charge transfer layer, the surface of the transfer layer of the donor sheet can be roughened using a plasma treatment.

Other embodiments include donor sheets and receptors that are plasma-treated, as well as articles and devices, such as electroluminescent devices, formed by the methods described above.

### BRIEF DESCRIPTION OF THE DRAWINGS

The invention may be more completely understood in consideration of the following detailed description of various embodiments of the invention in connection with the accompanying drawings, in which:

FIG. 1 is a schematic side view of an organic electroluminescent display construction;

FIG. 2 is a schematic side view of a donor sheet for transferring materials according to the present invention;

FIG. 3 is a schematic side view of an organic electroluminescent display according to the present invention;

FIG. 4A is a schematic side view of a first embodiment of an organic electroluminescent device;

FIG. 4B is a schematic side view of a second embodiment of an organic electroluminescent device;

FIG. 4C is a schematic side view of a third embodiment of an organic electroluminescent device; and

FIG. 4D is a schematic side view of a fourth embodiment of an organic electroluminescent device.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention contemplates materials and methods for the selective thermal patterning of a transfer element on a receptor substrate. These materials and methods can be used to form articles and devices such as, for example, electroluminescent devices. The methods and materials include the plasma treatment of a surface of an organic material (for example, a polymeric material) to improve thermal patterning. The methods and materials can be used to form, for example, devices such as organic electronic devices and displays that include electrically active organic materials including organic electroluminescent (OEL) devices. Electroluminescent and other devices and articles can include, for example, color filters, black matrix, spacers, polarizers, conductive layers, transistors, phosphors, and organic electroluminescent materials that are partially or completely transferred or otherwise formed by thermal patterning.

The terms “active” or “electrically active”, when used to refer to a layer or material in an organic electronic device, indicate layers or materials that perform a function during operation of the device, for example, producing, conducting, or semiconducting a charge carrier (e.g., electrons or holes), producing light, enhancing or tuning the electronic properties of the device construction, and the like. The term “non-active” refers to materials or layers that, although not directly contributing to functions as described above, may have some contribution to the assembly or fabrication or non-direct contribution to the functionality of an organic electronic device.

Materials, layers, or other structures can be selectively transferred from the transfer layer of a donor sheet to a receptor substrate by placing the transfer layer of the donor element adjacent to the receptor and selectively heating the donor element. For example, the donor element can be selectively heated by irradiating the donor element with imaging radiation that can be absorbed by light-to-heat converter material disposed in the donor, often in a separate LTHC layer, and converted into heat. Examples of such methods, donor elements and receptors, as well as articles and devices that can be formed using thermal transfer, can be found in U.S. Pat. Nos. 5,521,035, 5,691,098, 5,693,446, 5,695,907, 5,710,097, 5,725,989, 5,747,217, 5,766,827, 5,863,860, 5,897,727, 5,976,698, 5,981,136, 5,998,085, 6,057,067, 6,099,994, 6,114,088, 6,140,009, 6,190,826, 6,194,119, 6,221,543, 6,214,520, 6,221,553, 6,228,543, 6,228,555, 6,242,152, 6,270,934, and 6,270,944 and PCT Patent Applications Publication Nos. WO 00/69649 and WO 01/39986 and U.S. patent application Ser. Nos. 09/662,845, 09/662,980, 09/844,100, and 09/931,598, all of which are incorporated herein by reference. The donor can be exposed to imaging radiation through the donor substrate, through the receptor, or both. The radiation can include one or more wavelengths, including visible light, infrared radiation, or ultraviolet radiation, for example from a laser, lamp, or other radiation source.

Other selective heating methods can also be employed, such as using a thermal print head or using a thermal hot stamp (e.g., a patterned thermal hot stamp such as a heated silicone stamp that has a relief pattern that can be used to selectively heat a donor). Thermal print heads or other heating elements may be particularly suited for making lower resolution patterns of material or for patterning elements whose placement need not be precisely controlled. Plasma treatment of the receptor or transfer layer surface can be used to facilitate this type of transfer.

Material from the transfer layer can be selectively transferred to a receptor in this manner to imagewise form patterns of the transferred material on the receptor. In many instances, thermal transfer using light from, for example, a lamp or laser, to patternwise expose the donor can be advantageous because of the accuracy and precision that can often be achieved. The size and shape of the transferred pattern (e.g., a line, circle, square, or other shape) can be controlled by, for example, selecting the size of the light beam, the exposure pattern of the light beam, the duration of directed beam contact with the donor sheet, or the materials of the donor sheet. The transferred pattern can also be controlled by irradiating the donor element through a mask.

Transfer layers can also be transferred from donor sheets without selectively transferring the transfer layer. For example, a transfer layer can be formed on a donor substrate that, in essence, acts as a temporary liner that can be released after the transfer layer is contacted to a receptor substrate, typically with the application of heat or pressure. Such a method, referred to as lamination transfer, can be used to transfer the entire transfer layer, or a large portion thereof, to the receptor. Plasma treatment of the receptor or transfer layer surface can be used to facilitate this type of transfer.

To facilitate thermal transfer, the surface of the receptor that is to receive the transferred portions of the transfer layer can be subjected to a plasma treatment. Although the subsequent discussion will describe plasma treatment of the surface of the receptor, it will be recognized that the surface of the transfer layer that is to make contact with the receptor could be plasma treated in addition to or instead of the surface of the receptor. Plasma treatment of the receptor surface is illustrated as an example which can be readily adapted to plasma treatment of the surface of the transfer layer.

Plasma treatment can improve the accuracy and quality of the transfer. For example, transfer uniformity or edge roughness may be improved over transfer methods that do not utilize plasma treatment. Preferably, the plasma treatment roughens the surface of the receptor and, more preferably, the roughening is performed without substantially chemically modifying the surface or with only partially oxidizing the surface. Preferably, any oxidation of the surface is not substantially more than the oxidation that would be achieved by exposure to the environment during normal processing and storage of the receptor.

The absence of substantial chemical modification of the surface is preferably determined by X-ray photoelectron spectroscopy (XPS), also known as electron spectroscopy for chemical analysis (ESCA). XPS is generally a surface sensitive technique that typically indicates the elemental composition and chemical bonding state of the outermost 3 to 10 nm of a sample surface. XPS is sensitive to all elements (except hydrogen and helium), with detection limits down to 0.1 atomic %. In addition to the XPS analysis, the chemical composition of the surface can also be explored using time-of-flight secondary ion mass spectrometry (TOF-SIMS), which has monolayer sensitivity with an analysis depth in the range of 1 to 2 nm. The roughening of the surface is preferably detected using atomic force microscopy in tapping mode (TM-AFM). In particular, power spectral density plots derived from the AFM data can be used to illustrate the nanoscale roughening of the surface. In some embodiments, the surface can be roughened such that the average surface roughness is at least 0.5% or more of the thickness and can be 1%, 2%, 5% or more of the thickness.

Plasma treatment can be performed using a variety of different plasmas. For example, an RF plasma formed with a noble gas (such as argon), oxygen (O₂), nitrogen (N₂) or combinations thereof can typically be used to roughen a surface without substantially chemically modifying or only partially oxidizing the surface, as illustrated, for example, in the Examples below. Other useful plasmas include, for example, ECR (Electron Cyclotron Resonance) plasma, corona discharge or DC discharge plasma.

Relatively short exposure to the plasma, relatively low plasma power, or both can be used, if desired or necessary, to reduce, limit, or prevent chemical modification or oxidation of the plasma-treated surface. As one example of operating conditions, the plasma can have a power in the range of 20 to 200 W/cm² with a gas pressure in the range of 125 to 750 mTorr (about 16 to 100 Pa) and gas flow rates in the range of 20 to 500 sccm. Different power, gas pressure, and gas flow rates can be used, as desired and as needed to obtain desired effects for a particular plasma generating device. The exposure time can be in the range of, for example, 5 to 30 seconds (e.g., in the range of 10 to 30 seconds), however longer exposure times (for example, up to 1 minute or up to five or ten minutes or more) can be used, if desired.

Although it is typically preferable to limit chemical modification of the surface, other than partial oxidation, in some instances it can be desirable to generate a chemically modified surface using a plasma. Chemical modification can be accomplished by, for example, exposure to a fluorine-containing plasma, such as a CF₄ plasma, which results in the addition of fluorine to the surface or exposure to a silicon-containing plasma such as a tetramethylsilane (TMS) plasma which, depending on the conditions, can add, for example, silicon oxide, silicon hydroxide, silicon carbide, silicon hydride or silane groups to the surface. This may be desirable in some instances because the chemically modified surfaces can be resistant to adherence of other layers including transfer layers. For example, a CF₄ plasma can be used to selectively modify a surface of a receptor such that the modified surface is resistant to receiving a portion of the transfer layer. This can be used in conjunction with, for example, an argon, O₂, or N₂ plasma treatment to define a desired pattern of receptive (argon, O₂, or N₂ plasma treated) regions and non-receptive (CF₄ plasma treated) regions on the surface of a receptor.

Preferably, the plasma treatment results in improvement, retention, or only slight degradation in one or more, and more preferably all, important operational parameters of the device or article to be formed while achieving more accurate and higher quality transfer. For example, for electroluminescent devices operational voltage, brightness, and efficiency are important operational parameters. The desired brightness of the electroluminescent sample depends on the envisioned application. If the material were targeted toward an active matrix display application for instance, a brightness of approximately 200 Cd/m² may be desired for commercial applications. The operational voltage is that voltage which needs to be applied to the electroluminescent device in order to achieve the specified brightness. Low operational voltages, commonly from about 5 to about 20V or less, are desired.

One customary way to express the efficiency of an electroluminescent device is the quantity of emitted light per unit of current flow (units Cd/A). In general, the efficiency of the sample should be as high as possible. The specified efficiencies strongly depend on the color of the emitted light and the specific construction of the display: therefore, the stated efficiency can vary greatly depending on the application. As an example of the range of efficiencies for an active-matrix full-color display with a diagonal measurement of less than 15″ (0.381 m): the efficiency requirement can be in the range of 2 to 6 Cd/A for Red, to 15 Cd/A for Green, and 2 to 6 Cd/A for Blue.

A receptor surface that is plasma-treated is typically made of an organic material, as is the surface of the material that is to be transferred from the transfer layer and into contact with the receptor surface. Suitable organic materials include polymeric materials. For example, both the surface of the receptor and the transfer layer can be made of organic materials and, in some embodiments, both are made of polymeric materials.

The receptor can include a receptor substrate and one or more additional layers disposed on the substrate. The receptor substrate can be any item suitable for a particular application including, but not limited to, glass, transparent films, reflective films, metals, semiconductors, ceramic materials, and plastics. For example, receptor substrates can be any type of substrate or display element suitable for display applications. Receptor substrates suitable for use in displays such as liquid crystal displays or emissive displays include rigid or flexible substrates that are substantially transmissive to visible light. Examples of suitable rigid receptors include glass and rigid plastic that is coated or patterned with indium tin oxide or is circuitized with low temperature poly-silicon (LTPS) or other transistor structures, including organic transistors. Opaque substrates can also be used, including in embodiments where the light to be generated by an organic electroluminescent device formed on the receptor substrate is not meant to be transmitted through the substrate to a viewer or optical device.

Suitable flexible substrates include substantially clear and transmissive polymer films, reflective films, transflective films, polarizing films, multilayer optical films, and the like. Flexible substrates can also be coated or patterned with electrode materials or transistors, for example transistor arrays formed directly on the flexible substrate or transferred to the flexible substrate after being formed on a temporary carrier substrate. Suitable polymer substrates include polyester resins (e.g., polyethylene terephthalate, polyethylene naphthalate), polycarbonate resins, polyolefin resins, polyvinyl resins (e.g., polyvinyl chloride, polyvinylidene chloride, polyvinyl acetals, etc.), cellulose ester bases (e.g., cellulose triacetate, cellulose acetate), and other conventional polymeric films used as supports. For making organic electroluminescent devices on plastic substrates, it is often desirable to include a barrier film or coating on one or both surfaces of the plastic substrate to protect the organic light emitting devices and their electrodes from exposure to undesired levels of water, oxygen, and the like.

The receptor substrate is typically covered by one or more layers which provide an organic surface (for example, a polymeric surface) for plasma treatment. Receptor substrates can be covered by or pre-patterned with any one or more of the following: electrodes, transistors, capacitors, insulator ribs, spacers, color filters, black matrix, planarization layers, hole transport layers, electron transport layers, and other elements useful for electronic displays or other devices. Optionally, these additional layers are functional layers for the device or article to be formed. In one embodiment of an electroluminescent device, the surface of the receptor corresponds to a surface of a charge transfer layer (for example, an electron transfer layer, hole transfer layer, hole injection layer, electron injection layer, hole blocking layer, electron blocking layer, or buffer layer) that is disposed on a receptor substrate with optionally one or more intervening layers between the receptor substrate and the charge transfer layer. As an example, the charge transfer layer can be a conductive layer made of, for example, a homopolymer of, copolymer of, or polymer blend containing a substituted or unsubstituted polythiophene such as polyethylenedioxythiophene, a substituted or unsubstituted polypyrrole, or a substituted or unsubstituted polyaniline (PANI). It will be recognized that plasma treatment of a charge transfer layer of an electroluminescent device is just one example of the methods of the invention. Other layers or constructions could be disposed on the receptor substrate and plasma treated (or plasma treated as a layer of the transfer layer of the donor).

Returning to thermal transfer methods and materials, the mode of thermal mass transfer can vary depending on the type of selective heating employed, the type of irradiation if used to expose the donor, the type of materials and properties of an optional light-to-heat conversion (LTHC) layer, the type of materials in the transfer layer, the overall construction of the donor, the type of receptor substrate, and the like. Without wishing to be bound by any theory, transfer generally occurs via one or more mechanisms, one or more of which may be emphasized or de-emphasized during selective transfer depending on imaging conditions, donor constructions, and so forth. One mechanism of thermal transfer includes thermal melt-stick transfer whereby localized heating at the interface between the thermal transfer layer and the rest of the donor element can lower the adhesion of the thermal transfer layer to the donor in selected locations. Selected portions of the thermal transfer layer can adhere to the receptor more strongly than to the donor so that when the donor element is removed, the selected portions of the transfer layer remain on the receptor.

Another mechanism of thermal transfer includes ablative transfer whereby localized heating can be used to ablate portions of the transfer layer off the donor element, thereby directing ablated material toward the receptor. Yet another mechanism of thermal transfer includes sublimation whereby material dispersed in the transfer layer can be sublimated by heat generated in the donor element. A portion of the sublimated material can condense on the receptor.

The present invention contemplates transfer modes that include one or more of these and other mechanisms whereby selective heating of a donor sheet can be used to cause the transfer of materials from a transfer layer to receptor surface. Plasma treatment of the receptor or transfer layer surface can be used to facilitate transfer using any of the described mechanisms or combinations thereof.

A variety of radiation-emitting sources can be used to heat donor sheets. For analog techniques (e.g., exposure through a mask), high-powered light sources (e.g., xenon flash lamps and lasers) are useful. For digital imaging techniques, infrared, visible, and ultraviolet lasers are particularly useful. Suitable lasers include, for example, high power (≧100 mW) single mode laser diodes, fiber-coupled laser diodes, and diode-pumped solid state lasers (e.g., Nd:YAG and Nd:YLF). Laser exposure dwell times can vary widely from, for example, a few hundredths of microseconds to tens of microseconds or more, and laser fluences can be in the range from, for example, about 0.01 to about 5 J/cm² or more. Other radiation sources and irradiation conditions can be suitable based on, among other things, the donor element construction, the transfer layer material, the mode of thermal mass transfer, and other such factors.

When high spot placement accuracy is desired (e.g., when patterning elements for high information content displays and other such applications) over large substrate areas, a laser can be particularly useful as the radiation source. Laser sources are also compatible with both large rigid substrates (e.g., 1 m×1 m×1.1 mm glass) and continuous or sheeted film substrates (e.g., 100 μm thick polyimide sheets).

During imaging, the donor sheet can be brought into intimate contact with a receptor (as might typically be the case for thermal melt-stick transfer mechanisms) or the donor sheet can be spaced some distance from the receptor (as can be the case for ablative transfer mechanisms or material sublimation transfer mechanisms). In at least some instances, pressure or vacuum can be used to hold the donor sheet in intimate contact with the receptor. In some instances, a mask can be placed between the donor sheet and the receptor. Such a mask can be removable or can remain on the receptor after transfer. If a light-to-heat converter material is present in the donor, a radiation source can then be used to heat the LTHC layer (or other layer(s) containing radiation absorber) in an imagewise fashion (e.g., digitally or by analog exposure through a mask) to perform imagewise transfer or patterning of the transfer layer from the donor sheet to the receptor.

Typically, selected portions of the transfer layer are transferred to the receptor without transferring significant portions of the other layers of the donor sheet, such as the optional interlayer or LTHC layer. The presence of the optional interlayer may eliminate or reduce the transfer of material from an LTHC layer to the receptor or reduce distortion in the transferred portion of the transfer layer. Preferably, under imaging conditions, the adhesion of the optional interlayer to the LTHC layer is greater than the adhesion of the interlayer to the transfer layer. The interlayer can be transmissive, reflective, or absorptive to imaging radiation, and can be used to attenuate or otherwise control the level of imaging radiation transmitted through the donor or to manage temperatures in the donor, for example to reduce thermal or radiation-based damage to the transfer layer during imaging. Multiple interlayers can be present.

Large donor sheets can be used, including donor sheets that have length and width dimensions of a meter or more. In operation, a laser can be rastered or otherwise moved across the large donor sheet, the laser being selectively operated to illuminate portions of the donor sheet according to a desired pattern. Alternatively, the laser may be stationary and the donor sheet or receptor substrate moved beneath the laser.

In some instances, it may be necessary, desirable, or convenient to sequentially use two or more different donor sheets to form electronic devices on a receptor. For example, multiple layer devices can be formed by transferring separate layers or separate stacks of layers from different donor sheets. Multilayer stacks can also be transferred as a single transfer unit from a single donor element. For example, a hole transport layer and a light emitting layer can be co-transferred from a single donor. As another example, a semiconductive polymer and an emissive layer can be co-transferred from a single donor. Multiple donor sheets can also be used to form separate components in the same layer on the receptor. For example, three different donors that each have a transfer layer comprising a light emitter capable of emitting a different color (for example, red, green, and blue) can be used to form RGB sub-pixel OEL devices for a full color polarized light emitting electronic display. As another example, a conductive or semiconductive polymer can be patterned via thermal transfer from one donor, followed by selective thermal transfer of emissive layers from one or more other donors to form a plurality of OEL devices in a display. Plasma treatment of the receptor or transfer layer surface can be used to facilitate any of these transfer processes.

As still another example, layers for organic transistors can be patterned by selective thermal transfer of electrically active organic materials (oriented or not), followed by selective thermal transfer patterning of one or more pixel or sub-pixel elements such as color filters, emissive layers, charge transport layers, electrode layers, and the like. Plasma treatment of the receptor or transfer layer surface can be used to facilitate any of these transfer processes.

Materials from separate donor sheets can be transferred adjacent to other materials on a receptor to form adjacent devices, portions of adjacent devices, or different portions of the same device. Alternatively, materials from separate donor sheets can be transferred directly on top of, or in partial overlying registration with, other layers or materials previously patterned onto the receptor by thermal transfer or some other method (e.g., photolithography, deposition through a shadow mask, etc.). Plasma treatment of the receptor or transfer layer surface can be used to facilitate any of these transfer processes.

A variety of other combinations of two or more donor sheets can be used to form a device, each donor sheet forming one or more portions of the device. It will be understood that other portions of these devices, or other devices on the receptor, may be formed in whole or in part by any suitable process including photolithographic processes, ink jet processes, and various other printing or mask-based processes, whether conventionally used or newly developed.

As illustrated in FIG. 2, a donor sheet 200 can include a donor substrate 210, an optional underlayer 212, an optional light-to-heat conversion (LTHC) layer 214, an optional interlayer 216, and a transfer layer 218.

The donor substrate 210 can be a polymer film or any other suitable, preferably transparent, substrate. One suitable type of polymer film is a polyester film, for example, polyethylene terephthalate (PET) or polyethylene naphthalate (PEN) films. However, other films with sufficient optical properties, including high transmission of light at a particular wavelength, or sufficient mechanical and thermal stability properties, depending on the particular application, can be used. The donor substrate, in at least some instances, is flat so that uniform coatings can be formed thereon. The donor substrate is also typically selected from materials that remain stable despite heating of one or more layers of the donor. However, as described below, the inclusion of an underlayer between the substrate and an LTHC layer can be used to insulate the substrate from heat generated in the LTHC layer during imaging. The typical thickness of the donor substrate ranges from 0.025 to 0.15 mm, preferably 0.05 to 0.1 mm, although thicker or thinner donor substrates can be used.

The materials used to form the donor substrate and an optional adjacent underlayer can be selected to improve adhesion between the donor substrate and the underlayer, to control heat transport between the substrate and the underlayer, to control imaging radiation transport to the LTHC layer, to reduce imaging defects and the like. An optional priming layer can be used to increase uniformity during the coating of subsequent layers onto the substrate or increase the bonding strength between the donor substrate and adjacent layers or both, if desired.

An optional underlayer 212 may be coated or otherwise disposed between a donor substrate and the LTHC layer, for example to control heat flow between the substrate and the LTHC layer during imaging or to provide mechanical stability to the donor element for storage, handling, donor processing, or imaging. Examples of suitable underlayers and methods of providing underlayers are disclosed in U.S. Pat. No. 6,284,425, incorporated herein by reference.

The underlayer can include materials that impart desired mechanical or thermal properties to the donor element. For example, the underlayer can include materials that exhibit a low specific heat×density or low thermal conductivity relative to the donor substrate. Such an underlayer may be used to increase heat flow to the transfer layer, for example to improve the imaging sensitivity of the donor.

The underlayer can also include materials for their mechanical properties or for adhesion between the substrate and the LTHC. Using an underlayer that improves adhesion between the substrate and the LTHC layer can result in less distortion in the transferred image, if desired. As an example, in some cases an underlayer can be used that reduces or eliminates delamination or separation of the LTHC layer, for example, that might otherwise occur during imaging of the donor media. This can reduce the amount of physical distortion exhibited by transferred portions of the transfer layer. In other cases, however it may be desirable to employ underlayers that promote at least some degree of separation between or among layers during imaging, for example to produce an air gap between layers during imaging that can provide a thermal insulating function. Separation during imaging can also provide a channel for the release of gases that may be generated by heating of the LTHC layer during imaging. Providing such a channel can lead to fewer imaging defects.

The underlayer may be substantially transparent at the imaging wavelength, or can be at least partially absorptive or reflective of imaging radiation. Attenuation or reflection of imaging radiation by the underlayer can be used to control heat generation during imaging.

Referring again to FIG. 2, an LTHC layer 214 can be included in donor sheets of the present invention to couple irradiation energy into the donor sheet. The LTHC layer preferably includes a radiation absorber that absorbs incident radiation (e.g., laser light) and converts at least a portion of the incident radiation into heat to enable transfer of the transfer layer from the donor sheet to the receptor.

Generally, the radiation absorber(s) in the LTHC layer absorb light in the infrared, visible, or ultraviolet regions of the electromagnetic spectrum and convert the absorbed radiation into heat. The radiation absorber(s) are typically highly absorptive of the selected imaging radiation, providing an LTHC layer with an optical density at the wavelength of the imaging radiation in the range of about 0.2 to 3 or higher. Optical density of a layer is the absolute value of the logarithm (base 10) of the ratio of the intensity of light transmitted through the layer to the intensity of light incident on the layer.

Radiation absorber material can be uniformly disposed throughout the LTHC layer or can be non-homogeneously distributed. For example, as described in U.S. Pat. No. 6,228,555, non-homogeneous LTHC layers can be used to control temperature profiles in donor elements. This can give rise to donor sheets that have improved transfer properties (e.g., better fidelity between the intended transfer patterns and actual transfer patterns).

Suitable radiation absorbing materials can include, for example, dyes (e.g., visible dyes, ultraviolet dyes, infrared dyes, fluorescent dyes, and radiation-polarizing dyes), pigments, metals, metal compounds, metal films, and other suitable absorbing materials. Examples of suitable radiation absorbers include carbon black, metal oxides, and metal sulfides. One example of a suitable LTHC layer can include a pigment, such as carbon black, and a binder, such as an organic polymer. Another suitable LTHC layer includes metal or metal/metal oxide formed as a thin film, for example, black aluminum (i.e., a partially oxidized aluminum having a black visual appearance). Metallic and metal compound films may be formed by techniques, such as, for example, sputtering and evaporative deposition. Particulate coatings may be formed using a binder and any suitable dry or wet coating techniques. LTHC layers can also be formed by combining two or more LTHC layers containing similar or dissimilar materials. For example, an LTHC layer can be formed by vapor depositing a thin layer of black aluminum over a coating that contains carbon black disposed in a binder.

Dyes suitable for use as radiation absorbers in a LTHC layer can be present in particulate form, dissolved in a binder material, or at least partially dispersed in a binder material. When dispersed particulate radiation absorbers are used, the particle size can be, at least in some instances, about 10 μm or less, and may be about 1 μm or less. Suitable dyes include those dyes that absorb in the IR region of the spectrum. A specific dye can be chosen based on factors such as, solubility in, and compatibility with, a specific binder or coating solvent, as well as the wavelength range of absorption.

Pigmentary materials can also be used in the LTHC layer as radiation absorbers. Examples of suitable pigments include carbon black and graphite, as well as phthalocyanines, nickel dithiolenes, and other pigments described in U.S. Pat. Nos. 5,166,024 and 5,351,617. Additionally, black azo pigments based on copper or chromium complexes of, for example, pyrazolone yellow, dianisidine red, and nickel azo yellow can be useful. Inorganic pigments can also be used, including, for example, oxides and sulfides of metals such as aluminum, bismuth, tin, indium, zinc, titanium, chromium, molybdenum, tungsten, cobalt, iridium, nickel, palladium, platinum, copper, silver, gold, zirconium, iron, lead, and tellurium. Metal borides, carbides, nitrides, carbonitrides, bronze-structured oxides, and oxides structurally related to the bronze family (e.g., WO_{2.9}) may also be used.

Metal radiation absorbers may be used, either in the form of particles, as described for instance in U.S. Pat. No. 4,252,671, or as films, as disclosed in U.S. Pat. No. 5,256,506. Suitable metals include, for example, aluminum, bismuth, tin, indium, tellurium and zinc.

Suitable binders for use in the LTHC layer include film-forming polymers, such as, for example, phenolic resins (e.g., novolak and resole resins), polyvinyl butyral resins, polyvinyl acetates, polyvinyl acetals, polyvinylidene chlorides, polyacrylates, cellulosic ethers and esters, nitrocelluloses, and polyearbonates. Suitable binders can include monomers, oligomers, or polymers that have been, or can be, polymerized or crosslinked. Additives such as photoinitiators can also be included to facilitate crosslinking of the LTHC binder. In some embodiments, the binder is primarily formed using a coating of crosslinkable monomers or oligomers with optional polymer.

The inclusion of a thermoplastic resin (e.g., polymer) can improve, in at least some instances, the performance (e.g., transfer properties or coatability) of the LTHC layer. It is thought that a thermoplastic resin may improve the adhesion of the LTHC layer to the donor substrate. In one embodiment, the binder includes 25 to 50 wt. % (excluding the solvent when calculating weight percent) thermoplastic resin, and, preferably, 30 to 45 wt. % thermoplastic resin, although lower amounts of thermoplastic resin may be used (e.g., 1 to 15 wt. %). The thermoplastic resin is typically chosen to be compatible (i.e., form a one-phase combination) with the other materials of the binder. In at least some embodiments, a thermoplastic resin that has a solubility parameter in the range of 9 to 13 (cal/cm³)^{1/2}, preferably, 9.5 to 12 (cal/cm³)^{1/2}, is chosen for the binder. Examples of suitable thermoplastic resins include polyacrylics, styrene-acrylic polymers and resins, and polyvinyl butyral.

Conventional coating aids, such as surfactants and dispersing agents, can be added to facilitate the coating process. The LTHC layer can be coated onto the donor substrate using a variety of coating methods known in the art. A polymeric or organic LTHC layer can be coated, in at least some instances, to a thickness of 0.05 μm to 20 μm, preferably, 0.5 μm to 10 μm, and, more preferably, 1 μm to 7 μm. An inorganic LTHC layer can be coated, in at least some instances, to a thickness in the range of 0.0005 to 10 μm, and preferably, 0.001 to 1 μm.

Referring again to FIG. 2, an optional interlayer 216 can be disposed between the LTHC layer 214 and transfer layer 218. The interlayer can be used, for example, to minimize damage and contamination of the transferred portion of the transfer layer and may also reduce distortion in the transferred portion of the transfer layer. The interlayer can also influence the adhesion of the transfer layer to the rest of the donor sheet. Typically, the interlayer has high thermal resistance. Preferably, the interlayer does not distort or chemically decompose under the imaging conditions, particularly to an extent that renders the transferred image non-functional. The interlayer typically remains in contact with the LTHC layer during the transfer process and is not substantially transferred with the transfer layer.

Suitable interlayers include, for example, polymer films, metal layers (e.g., vapor deposited metal layers), inorganic layers (e.g., sol-gel deposited layers and vapor deposited layers of inorganic oxides (e.g., silica, titania, and other metal oxides)), and organic/inorganic composite layers. Organic materials suitable as interlayer materials include both thermoset and thermoplastic materials. Suitable thermoset materials include resins that can be crosslinked by heat, radiation, or chemical treatment including, but not limited to, crosslinked or crosslinkable polyacrylates, polymethacrylates, polyesters, epoxies, and polyurethanes. The thermoset materials can be coated onto the LTHC layer as, for example, thermoplastic precursors and subsequently crosslinked to form a crosslinked interlayer.

Suitable thermoplastic materials include, for example, polyacrylates, polymethacrylates, polystyrenes, polyurethanes, polysulfones, polyesters, and polyimides. These thermoplastic organic materials can be applied via conventional coating techniques (for example, solvent coating, spray coating, or extrusion coating). Typically, the glass transition temperature (T_{g}) of thermoplastic materials suitable for use in the interlayer is 25° C. or greater, preferably 50° C. or greater. In some embodiments, the interlayer includes a thermoplastic material that has a T_{g} greater than any temperature attained in the transfer layer during imaging. The interlayer can be either transmissive, absorbing, reflective, or some combination thereof, at the imaging radiation wavelength.

Inorganic materials suitable as interlayer materials include, for example, metals, metal oxides, metal sulfides, and inorganic carbon coatings, including those materials that are highly transmissive or reflective at the imaging light wavelength. These materials can be applied to the light-to-heat-conversion layer via conventional techniques (e.g., vacuum sputtering, vacuum evaporation, or plasma jet deposition).

The interlayer can provide a number of benefits, if desired. The interlayer can be a barrier against the transfer of material from the light-to-heat conversion layer. It can also modulate the temperature attained in the transfer layer so that thermally unstable materials can be transferred. For example, the interlayer can act as a thermal diffuser to control the temperature at the interface between the interlayer and the transfer layer relative to the temperature attained in the LTHC layer. This can improve the quality (i.e., surface roughness, edge roughness, etc.) of the transferred layer. The presence of an interlayer can also result in improved plastic memory in the transferred material.

The interlayer can contain additives, including, for example, photoinitiators, surfactants, pigments, plasticizers, and coating aids. The thickness of the interlayer can depend on factors such as, for example, the material of the interlayer, the material and properties of the LTHC layer, the material and properties of the transfer layer, the wavelength of the imaging radiation, and the duration of exposure of the donor sheet to imaging radiation. For polymer interlayers, the thickness of the interlayer typically is in the range of 0.05 μm to 10 μm. For inorganic interlayers (e.g., metal or metal compound interlayers), the thickness of the interlayer typically is in the range of 0.005 μm to 10 μm.

Referring again to FIG. 2, a thermal transfer layer 218 is included in donor sheet 200. Transfer layer 218 can include any suitable material or materials, disposed in one or more layers, alone or in combination with other materials. Transfer layer 218 is capable of being selectively transferred as a unit or in portions by any suitable transfer mechanism when the donor element is exposed to direct heating or to imaging radiation that can be absorbed by light-to-heat converter material and converted into heat. The transfer layer can then be selectively thermally transferred from the donor element to a proximately located receptor substrate. There can be, if desired, more than one transfer layer so that a multilayer construction is transferred using a single donor sheet. The exposed surface of the transfer layer is optionally plasma treated to facilitate adhesion of the transferred portion of the transfer layer to the receptor.

Organic electroluminescent (OEL) displays and devices are examples of articles that can be formed using thermal transfer as described herein. OEL displays and devices are further described to illustrate how articles can be made by thermal transfer. It will be recognized that a variety of different articles can be made using the techniques and materials described herein including the use of plasma treatment to facilitate transfer. OEL displays and devices include an organic (including organometallic) emissive material. The emissive material can include a small molecule (SM) emitter, a SM doped polymer, a light emitting polymer (LEP), a doped LEP, a blended LEP, or another organic emissive material whether provided alone or in combination with any other organic or inorganic materials that are functional or non-functional in the OEL display or devices

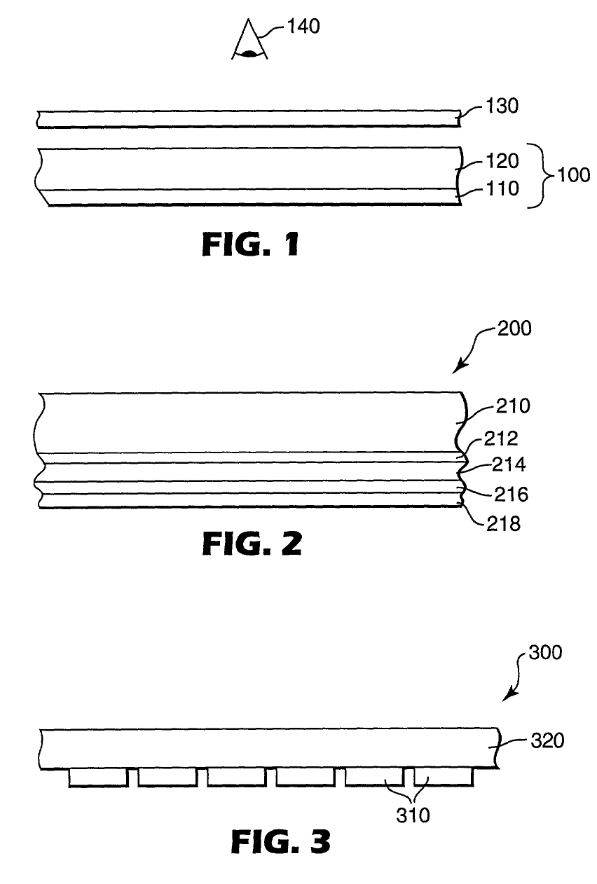

As an example of device structure, FIG. 1 illustrates an OEL display or device 100 that includes a device layer 110 and a substrate 120. Any other suitable display component can also be included with display 100. Optionally, additional optical elements or other devices suitable for use with electronic displays, devices, or lamps can be provided between display 100 and viewer position 140 as indicated by optional element 130.

In some embodiments like the one shown, device layer 110 includes one or more OEL devices that emit light through the substrate toward a viewer position 140. The viewer position 140 is used generically to indicate an intended destination for the emitted light whether it be an actual human observer, a screen, an optical component, an electronic device, or the like. In other embodiments (not shown), device layer 110 is positioned between substrate 120 and the viewer position 140. The device configuration shown in FIG. 1 (termed “bottom emitting”) may be used when substrate 120 is transmissive to light emitted by device layer 110 and when a transparent conductive electrode is disposed in the device between the emissive layer of the device and the substrate. The inverted configuration (termed “top emitting”) may be used when substrate 120 does or does not transmit the light emitted by the device layer and the electrode disposed between the substrate and the light emitting layer of the device does not transmit the light emitted by the device.

Device layer 110 can include one or more OEL devices arranged in any suitable manner. For example, in lamp applications (e.g., backlights for liquid crystal display (LCD) modules), device layer 110 can constitute a single OEL device that spans an entire intended backlight area. Alternatively, in other lamp applications, device layer 110 can constitute a plurality of closely spaced devices that can be contemporaneously activated. For example, relatively small and closely spaced red, green, and blue light emitters can be patterned between common electrodes so that device layer 110 appears to emit white light when the emitters are activated. Other arrangements for backlight applications are also contemplated.

In direct view or other display applications, it can be desirable for device layer 110 to include a plurality of independently addressable OEL devices that emit the same or different colors. Each device can represent a separate pixel or a separate sub-pixel of a pixilated display (e.g., high resolution display), a separate segment or sub-segment of a segmented display (e.g., low information content display), or a separate icon, portion of an icon, or lamp for an icon (e.g., indicator applications).

In at least some instances, an OEL device includes a thin layer, or layers, of one or more suitable organic materials sandwiched between a cathode and an anode. When activated, electrons are injected into the organic layer(s) from the cathode and holes are injected into the organic layer(s) from the anode. As the injected charges migrate towards the oppositely charged electrodes, they may recombine to form electron-hole pairs which are typically referred to as excitons. The region of the device in which the excitons are generally formed can be referred to as the recombination zone. These excitons, or excited state species, can emit energy in the form of light as they decay back to a ground state.

Other layers can also be present in OEL devices such as hole transport layers, electron transport layers, hole injection layer, electron injection layers, hole blocking layers, electron blocking layers, buffer layers, and the like. In addition, photoluminescent materials can be present in the electroluminescent or other layers in OEL devices, for example, to convert the color of light emitted by the electroluminescent material to another color. These and other such layers and materials can be used to alter or tune the electronic properties and behavior of the layered OEL device, for example to achieve a desired current/voltage response, a desired device efficiency, a desired color, a desired brightness, and the like.

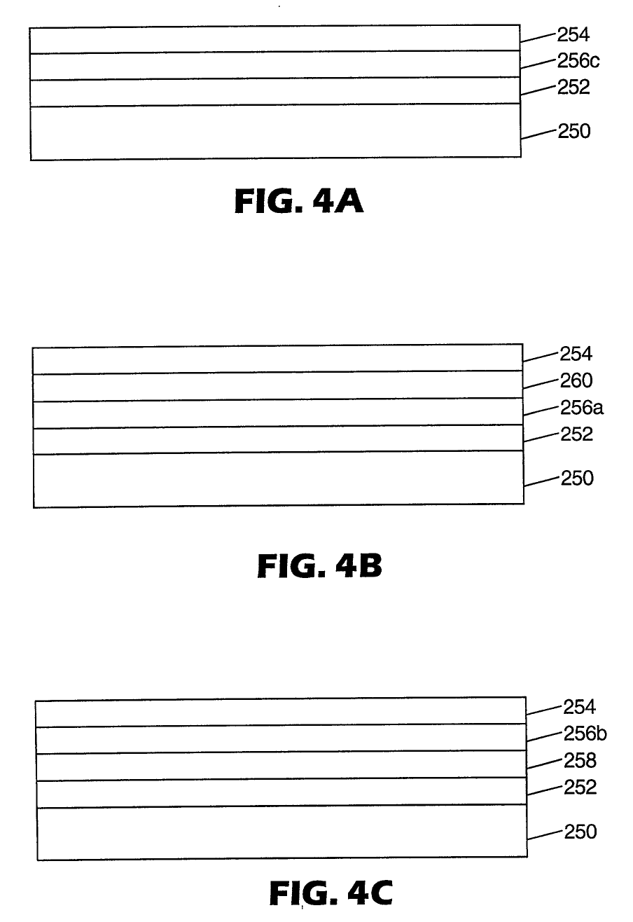

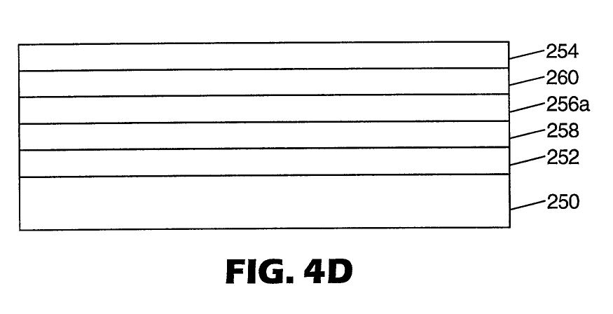

FIGS. 4A to 4D illustrate examples of different OEL device configurations. Each configuration includes a substrate 250, an anode 252, a cathode 254, and a light emitting layer 256. The configurations of FIGS. 4C and 4D also include a hole transport layer 258 and the configurations of FIGS. 4B and 4D include an electron transport layer 260. These layers conduct holes from the anode or electrons from the cathode, respectively.

The anode 252 and cathode 254 are typically formed using conducting materials such as metals, alloys, metallic compounds, metal oxides, conductive ceramics, conductive dispersions, and conductive polymers, including, for example, gold, platinum, palladium, aluminum, calcium, titanium, titanium nitride, indium tin oxide (ITO), fluorine tin oxide (FTO), and polyaniline. The anode 252 and the cathode 254 can be single layers of conducting materials or they can include multiple layers. For example, an anode or a cathode may include a layer of aluminum and a layer of gold, a layer of calcium and a layer of aluminum, a layer of aluminum and a layer of lithium fluoride, or a metal layer and a conductive organic layer.

The hole transport layer 258 facilitates the injection of holes from the anode into the device and their migration towards the recombination zone. The hole transport layer 258 can further act as a barrier for the passage of electrons to the anode 252. The hole transport layer 258 can include, for example, a diamine derivative, such as N,N′-bis(3-methylphenyl)-N,N′-bis(phenyl)benzidine (also known as TPD) or N,N′-bis(3-naphthalen-2-yl)-N,N′-bis(phenyl)benzidine (NPB), or a triarylamine derivative, such as, 4,4′,4″-Tris(N,N-diphenylamino)triphenylamine (TDATA) or 4,4′,4″-Tris(N-3-methylphenyl-N-phenylamino)triphenylamine (mTDATA). Other examples include copper phthalocyanine (CuPC); 1,3,5-Tris(4-diphenylaminophenyl)benzenes (TDAPBs); and other compounds such as those described in H. Fujikawa, et al., Synthetic Metals, 91, 161 (1997) and J. V. Grazulevicius, P. Strohriegl, “Charge-Transporting Polymers and Molecular Glasses”, Handbook of Advanced Electronic and Photonic Materials and Devices, H. S. Nalwa (ed.), 10, 233-274 (2001), both of which are incorporated herein by reference.

The electron transport layer 260 facilitates the injection of electrons and their migration towards the recombination zone. The electron transport layer 260 can further act as a barrier for the passage of holes to the cathode 254, if desired. As an example, the electron transport layer 260 can be formed using the organometallic compound tris(8-hydroxyquinolato) aluminum (Alq3). Other examples of electron transport materials include 1,3-bis[5-(4-(1,1-dimethylethyl)phenyl)-1,3,4-oxadiazol-2-yl]benzene, 2-(biphenyl-4-yl)-5-(4-(1,1-dimethylethyl)phenyl)-1,3,4-oxadiazole (tBuPBD) and other compounds described in C. H. Chen, et al., Macromol. Symp. 125, 1 (1997) and J. V. Grazulevicius, P. Strohriegl, “Charge-Transporting Polymers and Molecular Glasses”, Handbook of Advanced Electronic and Photonic Materials and Devices, H. S. Nalwa (ed.),10, 233 (2001), both of which are incorporated herein by reference.

Each configuration also includes a light emitting layer 256 that includes one or more light emitting polymers (LEP) or other light emitting molecules (e.g., small molecule (SM) light emitting compounds). A variety of light emitting materials including LEP and SM light emitters can be used. Examples of classes of suitable LEP materials include poly(phenylenevinylene)s (PPVs), poly-para-phenylenes (PPPs), polyfluorenes (PFs), other LEP materials now known or later developed, and co-polymers or blends thereof. Suitable LEPs can also be molecularly doped, dispersed with fluorescent dyes or other PL materials, blended with active or non-active materials, dispersed with active or non-active materials, and the like. Examples of suitable LEP materials are described in Kraft, et al., Angew. Chem. Int. Ed., 37, 402-428 (1998); U.S. Pat. Nos. 5,621,131; 5,708,130; 5,728,801; 5,840,217; 5,869,350; 5,900,327; 5,929,194; 6,132,641; and 6,169,163; and PCT Patent Application Publication No. 99/40655, all of which are incorporated herein by reference.

SM materials are generally non-polymer organic or organometallic molecular materials that can be used in OEL displays and devices as emitter materials, charge transport materials, as dopants in emitter layers (e.g., to control the emitted color) or charge transport layers, and the like. Commonly used SM materials include metal chelate compounds, such as tris(8-hydroxyquinoline) aluminum (Alq3), and N,N′-bis(3-methylphenyl)-N,N′-diphenylbenzidine (TPD). Other SM materials are disclosed in, for example, C. H. Chen, et al., Macromol. Symp. 125, 1 (1997), Japanese Laid Open Patent Application 2000-195673, U.S. Pat. Nos. 6,030,715, 6,150,043, and 6,242,115 and, PCT Patent Applications Publication Nos. WO 00/18851 (divalent lanthanide metal complexes), WO 00/70655 (cyclometallated iridium compounds and others), and WO 98/55561, all of which are incorporated herein by reference.

Referring back to FIG. 1, device layer 110 is disposed on substrate 120. Substrate 120 can be any substrate suitable for OEL device and display applications. For example, substrate 120 can comprise glass, clear plastic, or other suitable material(s) that are substantially transparent to visible light. Substrate 120 can also be opaque to visible light, for example stainless steel, crystalline silicon, poly-silicon, or the like. Because some materials in OEL devices can be particularly susceptible to damage due to exposure to oxygen or water, substrate 120 preferably provides an adequate environmental barrier, or is supplied with one or more layers, coatings, or laminates that provide an adequate environmental barrier.

Substrate 120 can also include any number of devices or components suitable in OEL devices and displays such as transistor arrays and other electronic devices; color filters, polarizers, wave plates, diffusers, and other optical devices; insulators, barrier ribs, black matrix, mask work and other such components; and the like. Generally, one or more electrodes will be coated, deposited, patterned, or otherwise disposed on substrate 120 before forming the remaining layer or layers of the OEL device or devices of the device layer 110. When a light transmissive substrate 120 is used and the OEL device or devices are bottom emitting, the electrode or electrodes that are disposed between the substrate 120 and the emissive material(s) are preferably substantially transparent to light, for example transparent conductive electrodes such as indium tin oxide (ITO) or any of a number of other transparent conductive oxides.

Element 130 can be any element or combination of elements suitable for use with OEL display or device 100. For example, element 130 can be an LCD module when device 100 is a backlight. One or more polarizers or other elements can be provided between the LCD module and the backlight device 100, for instance an absorbing or reflective clean-up polarizer. Alternatively, when device 100 is itself an information display, element 130 can include one or more of polarizers, wave plates, touch panels, antireflective coatings, anti-smudge coatings, projection screens, brightness enhancement films, or other optical components, coatings, user interface devices, or the like.

Organic electronic devices containing materials for light emission can be made at least in part by selective thermal transfer of light emitting material from a thermal transfer donor sheet to a desired receptor substrate. One or more different thermal transfer steps can occur. Each thermal transfer step can include the transfer of one or more layers to form the structure. Individual layers can optionally be formed by several transfer steps. For each transfer step, the receptor or transfer layer surface can be plasma treated to facilitate transfer. As an example, the transfer layer can include a light emitting layer, an active layer (e.g., an electrically active layer such as a layer that produces, conducts, or semiconducts a charge carrier), or a combination thereof. In addition to thermal transfer techniques, some layers may be formed using other techniques including, for example, chemical or physical vapor deposition, sputtering, spin coating, and other coating methods.

The present invention contemplates light emitting OEL displays and devices. In one embodiment, OEL displays can be made that emit light and that have adjacent devices that can emit light having different color. For example, FIG. 3 shows an OEL display 300 that includes a plurality of OEL devices 310 disposed on a substrate 320. Adjacent devices 310 can be made to emit different colors of light.

The separation shown between devices 310 is for illustrative purposes only. Adjacent devices may be separated, in contact, overlapping, etc., or different combinations of these in more than one direction on the display substrate. For example, a pattern of parallel striped transparent conductive anodes can be formed on the substrate followed by a striped pattern of a hole transport material and a striped repeating pattern of red, green, and blue light emitting LEP layers, followed by a striped pattern of cathodes, the cathode stripes oriented perpendicular to the anode stripes. Such a construction may be suitable for forming passive matrix displays. In other embodiments, transparent conductive anode pads can be provided in a two-dimensional pattern on the substrate and associated with addressing electronics such as one or more transistors, capacitors, etc., such as are suitable for making active matrix displays. Other layers, including the light emitting layer(s) can then be coated or deposited as a single layer or can be patterned (e.g., parallel stripes, two-dimensional pattern commensurate with the anodes, etc.) over the anodes or electronic devices. Any other suitable construction is also contemplated by the present invention.

In one embodiment, display 300 can be a multiple color display. As such, it may be desirable to position optional polarizer 330 between the light emitting devices and a viewer, for example to enhance the contrast of the display. In exemplary embodiments, each of the devices 310 emits light. There are many displays and devices constructions covered by the general construction illustrated in FIG. 3. Some of those constructions are discussed as follows.

OEL backlights can include emissive layers. Constructions can include bare or circuitized substrates, anodes, cathodes, hole transport layers, electron transport layers, hole injection layers, electron injection layers, emissive layers, color changing layers, and other layers and materials suitable in OEL devices. Constructions can also include polarizers, diffusers, light guides, lenses, light control films, brightness enhancement films, and the like. Applications include white or single color large area single pixel lamps, for example where an emissive material is provided by thermal stamp transfer, lamination transfer, resistive head thermal printing, or the like; white or single color large area single electrode pair lamps that have a large number of closely spaced emissive layers patterned by laser induced thermal transfer; and tunable color multiple electrode large area lamps.

Low resolution OEL displays can include emissive layers. Constructions can include bare or circuitized substrates, anodes, cathodes, hole transport layers, electron transport layers, hole injection layers, electron injection layers, emissive layers, color changing layers, and other layers and materials suitable in OEL devices. Constructions can also include polarizers, diffusers, light guides, lenses, light control films, brightness enhancement films, and the like. Applications include graphic indicator lamps (e.g., icons); segmented alphanumeric displays (e.g., appliance time indicators); small monochrome passive or active matrix displays; small monochrome passive or active matrix displays plus graphic indicator lamps as part of an integrated display (e.g., cell phone displays); large area pixel display tiles (e.g., a plurality of modules, or tiles, each having a relatively small number of pixels), such as may be suitable for outdoor display used; and security display applications.

High resolution OEL displays can include emissive layers. Constructions can include bare or circuitized substrates, anodes, cathodes, hole transport layers, electron transport layers, hole injection layers, electron injection layers, emissive layers, color changing layers, and other layers and materials suitable in OEL devices. Constructions can also include polarizers, diffusers, light guides, lenses, light control films, brightness enhancement films, and the like. Applications include active or passive matrix multicolor or full color displays; active or passive matrix multicolor or full color displays plus segmented or graphic indicator lamps (e.g., laser induced transfer of high resolution devices plus thermal hot stamp of icons on the same substrate); and security display applications.

### EXAMPLES

### Example 1

### Preparation of Receptors

Five different types of receptors were formed: (A) Indium tin oxide (ITO) coated with a film of poly(3,4-ethylenedioxythiophene)-polystyrenesulfonate (PDOT), (B) ITO/PDOT treated with an oxygen-containing plasma, (C) ITO/PDOT treated with an argon-containing plasma, (D) ITO/PDOT treated with a plasma containing tetrafluoromethane (CF₄), and (E) ITO/PDOT treated with a plasma containing tetramethylsilane (TMS) and argon.

(A) Indium tin oxide (ITO) coated glass (Delta Technologies, Stillwater, Minn., less than 100 Ω/square, 1.1 mm thick) was ultrasonically cleaned in a hot, 3% solution of Deconex 12 NS (Borer Chemie AG, Zuchwil, Switzerland). The substrates were then placed in a Plasma Science plasma treater (Model PS 500 available from AST Inc., Billerica, Mass.) for surface treatment under the following conditions:

| | | |
|---|---|---|
| Time: | 2 | minutes |
| Power: | 500 | W (165 W/cm²) |
| Oxygen Flow: | 100 | sccm |
| Pressure: | 300 | mTorr |

Immediately after plasma treatment, the PDOT solution (CH8000 from Bayer AG, Leverkusen, Germany, diluted with deionized water 1:1) was filtered and dispensed onto the ITO through a Whatman Puradisk™ 0.45 μm polypropylene (PP) filter. The substrate was then spun (Headway Research spincoater) at 2000 rpm for 30 s yielding a PDOT film thickness of 40 nm. The PDOT coated substrate was heated to 200° C. for 5 minutes under nitrogen.

(B) The O₂ plasma-treated receptor was made using the PDOT coated substrate prepared as described for receptor surface (A) and placed into the Plasma Science plasma treater for surface treatment under the following conditions:

| | | |
|---|---|---|
| Time: | 10 | s |
| Power: | 100 | W (33 W/cm²) |
| Oxygen Flow: | 100 | sccm |
| Pressure: | 750 | mTorr |

(C) The argon plasma-treated receptor was made using the PDOT coated substrate prepared as described for receptor surface (A) and placed into the Plasma Science plasma treater for surface treatment under the following conditions:

| | | |
|---|---|---|
| Time: | 20 | s |
| Power: | 500 | W (165 W/cm²) |
| Argon Flow: | 20 | sccm |
| Pressure: | 125 | mTorr |

(D) The CF₄ plasma-treated receptor was made using the PDOT coated substrate prepared as described for receptor surface (A) and placed into the Plasma Science plasma treater for surface treatment under the following conditions:

| | | |
|---|---|---|
| Time: | 15 | s |
| Power: | 300 | W (100 W/cm²) |
| CF₄ Flow: | 170 | sccm |
| Pressure: | 175 | mTorr |

(E) The TMS plasma-treated receptor was made using the PDOT coated substrate prepared as described for receptor surface (A) and placed into the Plasma Science plasma treater for surface treatment under the following conditions:

| | | |
|---|---|---|
| Time: | 15 | s |
| Power: | 500 | W (165 W/cm²) |
| TMS Flow: | 20 | sccm |
| Argon Flow: | 500 | sccm |
| Pressure: | 450 | mTorr |

The receptor surfaces were characterized using X-ray Photoelectron Spectroscopy (XPS, also known as Electron Spectroscopy for Chemical Analysis (ESCA)) and Atomic Force Microscopy (AFM).

Receptors of types (A), (B) and (C) were analyzed by XPS using a Surface Science SSX-100 instrument with a monochromated A1 X-ray source. The photoemission was detected at a 35° take-off angle with respect to the receptor surface. The ESCA data did not show any significant differences in the surface composition of the 3 samples.

TABLE I
Results in atomic % (an average of duplicate measurements) of the XPS analysis for
receptor surfaces (A), (B) and (C)

| SAMPLE | Carbon | Oxygen | Sulfur | Nitrogen | Indium | Tin | Sodium |
|---|---|---|---|---|---|---|---|
| (A) untreated | 67 | 21 | 6.9 | 2.0 | 2.1 | 0.1 | 0.8 |
| PDOT | | | | | | | |
| (B) O₂-treated | 66 | 23 | 6.3 | 1.4 | 2.5 | 0.2 | 0.3 |
| PDOT | | | | | | | |
| (C) Ar-treated | 66 | 24 | 5.4 | 1.9 | 1.8 | 0.1 | 0.7 |
| PDOT | | | | | | | |

Receptors of types (A), (D) and (E) were analyzed by XPS using an ESCA system with a non-monochromated A1 X-ray source. The photoemission was detected at a 30° take-off angle with respect to the receptor surface. In the case of receptor (D), a degree of fluorination and trace amounts of silicon were detected on the surface. In the case of receptor (E), silicon was detected but sulfur was not suggesting that the PDOT film is covered with a silicon-containing overlayer, which is thicker then the sampling depth of ESCA (on the order of ˜8 nm thickness).

TABLE II
Results in atomic % of the XPS analysis for receptor surfaces (A), (D) and (E)

| SAMPLE | Carbon | Oxygen | Sulfur | Nitrogen | Fluorine | Silicon |
|---|---|---|---|---|---|---|
| (A) untreated | 66 ± 2 | 21 ± 2 | 7.1 ± 0.4 | 1.4 ± 0.3 | — | — |
| PDOT | | | | | | |
| (D) CF₄- | 63 ± 1 | 24 ± 1 | 6.8 ± 0.1 | 1.3 ± 0.3 | 1.0 ± 0.1 | ≦1.3 |
| treated PDOT | | | | | | |
| (E) TMS/Ar- | 60 ± 2 | 18 ± 1 | — | — | — | 21 ± 1 |
| treated PDOT | | | | | | |

Receptors of types (B) and (C) were characterized using Atomic Force Microscopy (AFM), and receptors of type (A) were also characterized by AFM for comparison. The surfaces of the receptors from type (B) and (C) were roughened compared to surfaces of receptors from type (A).

The effect of Ar-plasma treatment was observed when a substrate of type (A) was plasma treated through a 2000-mesh copper grid shadow mask using the treatment conditions as described in example 1 for receptor (C). Tapping mode AFM images were captured using a Digital Instruments Dimension 5000 Scanning Probe Microscope. The probes used were Olympus (OTESPA) tapping-mode probes with a nominal force constant of 40 N/m. It was apparent from the AFM images that the unmasked, e.g. plasma-treated, regions of the sample were roughened compared to the masked, e.g. non-treated, regions. A power spectral density plot of the two regions showed that the unmasked, e.g. plasma-treated, regions had a higher occurrence of features of 50 nm and below in dimension. As an example of the RMS roughness change in the spectral range of 50 nm to 10 nm: the control non-treated PEDOT film (Example 1, receptor A) showed a RMS roughness of 0.27-0.35 nm, while the plasma treated PEDOT film (Example 1, receptor C) showed a RMS roughness of 0.43-0.50 nm.

### Example 2

### Preparation of a Donor Sheet without a Transfer Laver

A thermal transfer donor sheet was prepared in the following manner:

An LTHC solution, given in Table III, was coated onto a 0.1 mm thick polyethylene terephthalate (PET) film substrate (M7 from Teijin, Osaka, Japan). Coating was performed using a Yasui Seiki Lab Coater, Model CAG-150, using a microgravure roll with 150 helical cells per inch. The LTHC coating was in-line dried at 80° C. and cured under ultraviolet (UV) radiation.

TABLE III
LTHC Coating Solution

| | | Parts |
|---|---|---|
| | | by |
| Component | Trade Designation | Weight |
| carbon black pigment | Raven 760 Ultra⁽¹⁾ | 3.55 |
| polyvinyl butyral resin | Butvar B-98⁽²⁾ | 0.63 |
| acrylic resin | Joncryl 67⁽³⁾ | 1.90 |
| dispersant | Disperbyk 161⁽⁴⁾ | 0.32 |
| surfactant | FC-430⁽⁵⁾ | 0.09 |
| epoxy novolac acrylate | Ebecryl 629⁽⁶⁾ | 12.09 |
| acrylic resin | Elvacite 2669⁽⁷⁾ | 8.06 |
| 2-benzyl-2-(dimethylamino)-1-(4- | Irgacure 369⁽⁸⁾ | 0.82 |
| (morpholinyl) phenyl) butanone | | |
| 1-hydroxycyclohexyl phenyl ketone | Irgacure 184⁽⁸⁾ | 0.12 |
| 2-butanone | | 45.31 |
| 1,2-propanediol monomethyl ether | | 27.19 |
| acetate | | |

⁽¹⁾available from Columbian Chemicals Co., Atlanta, GA
⁽²⁾available from Solutia Inc., St. Louis, MO
⁽³⁾available from S. C. Johnson & Son, Inc. Racine, WI
⁽⁴⁾available from Byk-Chemie USA, Wallingford, CT
⁽⁵⁾available from Minnesota Mining and Manufacturing Co., St. Paul, MN
⁽⁶⁾available from UCB Radcure Inc., N. Augusta, SC
⁽⁷⁾available from ICI Acrylics Inc., Memphis, TN
⁽⁸⁾available from Ciba-Geigi Corp., Tarrytown, NY

Next, an interlayer solution, given in Table IV, was coated onto the cured LTHC layer by a rotogravure coating method using the Yasui Seiki lab coater, Model CAG-150, with a microgravure roll having 180 helical cells per lineal inch. This coating was in-line dried at 60° C. and cured under ultraviolet (UV) radiation.

TABLE IV
Interlayer Coating Solution

| | PARTS BY |
|---|---|
| COMPONENT | WEIGHT |
| SR 351 HP (trimethylolpropane triacrylate | 14.85 |
| ester, available from Sartomer, Exton, PA) | |
| Butvar B-98 | 0.93 |
| Joncryl 67 | 2.78 |
| Irgacure 369 | 1.25 |
| Irgacure 184 | 0.19 |
| 2-butanone | 48.00 |
| 1-methoxy-2-propanol | 32.00 |

### Example 3

### Preparation of Solutions for Transfer Layer

The following solutions were prepared:

(a) Covion Green: Covion Green PPV polymer HB 1270 (100 mg) from Covion Organic Semiconductors GmbH, Frankfurt, Germany was weighed out into an amber vial with a PTFE cap. To this was added 9.9 g of toluene (HPLC grade obtained from Aldrich Chemical, Milwaukee, Wis.). The vial containing the solution was placed into a silicone oil bath and the solution was stirred at 75° C. for 60 minutes. The solution was filtered hot through a 0.45 μm polypropylene (PP) syringe filter.

(b) Covion Super Yellow: Covion PPV polymer PDY 132 “Super Yellow” (75 mg) from Covion Organic Semiconductors GmbH, Frankfurt, Germany was weighed out into an amber vial with a PTFE cap. To this was added 9.925 g of toluene (HPLC grade obtained from Aldrich Chemical, Milwaukee, Wis.). The solution was stirred over night. The solution was filtered through a 5 μm Millipore Millex syringe filter.

(c) Polystyrene: Polystyrene (250 mg) from Aldrich Chemical, Milwaukee, Wis. (M_{w}=2,430) was dissolved in 9.75 g of toluene (HPLC grade obtained from Aldrich Chemical, Milwaukee, Wis.). The solution was filtered through a 0.45 μm polypropylene (PP) syringe filter.

### Examples 4-6

### Preparation of Transfer Layers on Donor Sheet and Transfer of Transfer Layers.

Transfer layers were formed on the donor sheets of Example 2 using blends of the Solutions of Example 3 according to Table V. To obtain the blends, the above described solutions were mixed at the appropriate ratios and the resulting blend solutions were stirred for 20 min at room temperature.

The transfer layers were disposed on the donor sheets by spinning (Headway Research spincoater) at about 2000-2500 rpm for 30 s to yield a film thickness of approximately 100 nm.

TABLE V
Parts by Weight of Transfer Layer Compositions

| Example number | Covion Green | Covion Super Yellow | Polystyrene |
|---|---|---|---|
| 4 | 1 | — | 2 |
| 5 | 1 | — | 3 |
| 6 | — | 1 | 2 |

Donor sheets as prepared in Examples 4-6 were brought into contact with receptor substrates as prepared in Example 1. Next, the donors were imaged using two single-mode Nd:YAG lasers. Scanning was performed using a system of linear galvanometers, with the combined laser beams focused onto the image plane using an f-theta scan lens as part of a near-telecentric configuration. The laser energy density was 0.4 to 0.8 J/cm². The laser spot size, measured at the 1/e² intensity, was 30 micrometers by 350 micrometers. The linear laser spot velocity was adjustable between 10 and 30 meters per second, measured at the image plane. The laser spot was dithered perpendicular to the major displacement direction with about a 100 μm amplitude. The transfer layers were transferred as lines onto the receptor substrates, and the intended width of the lines was about 100 μm.

The transfer layers were transferred in a series of lines that were in overlying registry with the ITO stripes on the receptor substrates. The results of imaging are given in Table VI.

TABLE VI
Transfer Results

| Example | Transfer to receptor (A) - untreated | Transfer to receptor (C) - PDOT |
|---|---|---|
| number | PDOT | treated with Ar Plasma |
| 4 | transferred lines have hole defects | excellent transfer; transferred lines |
| | down the middle of the line and some | are defect free and have a smooth |
| | edge roughness | edge |
| 5 | transferred lines have hole defects | excellent transfer; transferred lines |
| | down the middle of the line; excellent | are defect free; excellent edge |
| | edge quality | quality |
| 6 | spotty transfer; no continuous lines | good transfer with rough edges |

Similar improvement in transfer quality was achieved by using O₂ plasma treatment (receptor surface (B) as described in Example 1). Treatment with CF₄ plasma (receptor surface (D) as described in Example 1) prevented transfer.

### Examples 7

### Preparation of OEL Devices

The effect of plasma treatment on the performance of an OEL device has been explored using spin-coated, devices which contained ITO/PDOT, ITO/O₂-plasma-treated PDOT and ITO/Ar-plasma-treated PDOT (preparation and plasma conditions as described in Example 1, receptor surfaces (A), (B) and (C)). On top of the receptor surface (A), (B) or (C) was deposited the solution of Covion Green (Example 3, solution (a)). A film (ca. 100 nm thick) of Covion Green was formed by spin-coating at 2500 rpm for 30 s using the Headway Research spin coater. Subsequently, Ca/Ag cathodes were vacuum vapor deposited using the following conditions:

| | Thickness | Rate | Coating time |
|---|---|---|---|
| Ca | 400 A | 1.1 A/s | 5 min 51 s |
| Ag | 4000 A | 5.0 A/s | 13 min 20 s |

In all cases diode behavior and green light emission were observed. The efficiency and operational voltage of the devices containing receptor surfaces (A), (B) and (C) did not significantly differ, showing that treatment of a PDOT film using O₂ or Ar plasma under the conditions as described in Example 1, did not significantly affect the performance of an OEL device.

OEL devices, which contained CF₄-treated PDOT (receptor surface (D)) showed slightly improved efficiency and increased operational voltage. OEL devices, which contained TMS/Ar-treated PDOT (receptor surface (E)) showed low efficiency.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

Each of the patents, patent documents, and publications cited above is hereby incorporated into this document as if reproduced in full.

What is claimed is:

1. A method of transferring a transfer element of a donor sheet to a receptor, the method comprising:
forming an organic charge transfer layer on a receptor substrate;
roughening a surface of the charge transfer layer using a plasma treatment; and
selectively thermally transferring a transfer element of a donor sheet to the surface of the charge transfer layer after roughening the surface, the transfer element comprising at least one light emitting layer.

2. The method of claim 1, wherein the surface of the charge transfer layer is not substantially chemically modified by the plasma treatment.

3. The method of claim 1, wherein the organic charge transfer layer is a polymeric charge transfer layer.

4. The method of claim 1, wherein the polymeric charge transfer layer comprises a homopolymer or copolymer of a polythiophene.

5. The method of claim 1, wherein the surface of the charge transfer layer is at least partially oxidized, but not otherwise substantially chemically modified, by the plasma treatment.

6. The method of claim 1, wherein roughening the surface comprises roughening the surface using a plasma comprising a noble gas.

7. The method of claim 6, wherein the noble gas comprises argon.

8. The method of claim 1, wherein roughening the surface comprises roughening the surface using a plasma comprising O₂.

9. The method of claim 1, wherein roughening the surface comprises roughening the surface using a plasma comprising N₂.

10. The method of claim 1, wherein roughening the surface comprises roughening the surface for a period of no more than 30 seconds.

11. The method of claim 1, wherein roughening the surface comprises roughening the surface with a plasma gas at a pressure of no more than 750 mTorr.

12. A method of making an electroluminescent device, the method comprising:
forming an electrode on a receptor substrate
forming an organic charge transfer layer over the electrode;
roughening a surface of the charge transfer layer using a plasma treatment; and
selectively thermally transferring a transfer element of a donor sheet to the surface of the charge transfer layer after roughening the surface, the transfer element comprising at least one light emitting layer.

13. The method of claim 12, wherein the electroluminescent device has no substantial degradation in brightness as compared to an electroluminescent device made in a same manner except no roughening of the surface using a plasma treatment.

14. The method of claim 12, wherein the electroluminescent device has no substantial degradation in operating voltage as compared to an electroluminescent device made in a same manner except no roughening of the surface using a plasma treatment.

15. The method of claim 12, wherein the electroluminescent device has no substantial degradation in efficiency as compared to an electroluminescent device made in a same manner except no roughening of the surface using a plasma treatment.

16. A method of transferring a transfer element of a donor sheet to a receptor, the method comprising:
forming an organic layer on a receptor substrate;
roughening a surface of the organic layer using a plasma treatment; and
selectively thermally transferring a transfer element of a donor sheet to the surface of the organic layer after roughening the surface, the transfer element comprising an organic surface that contacts the organic layer of the receptor substrate.

17. A method of transferring a transfer element of a donor sheet to a receptor, the method comprising:
forming an organic layer on a receptor substrate;
forming a transfer element on a donor sheet, wherein an exposed surface of the transfer element is organic;
roughening, using a plasma treatment, at least one of (i) a surface of the organic layer and (ii) the exposed surface of the transfer element; and
selectively thermally transferring the transfer element of the donor sheet to the surface of the organic layer after roughening.

18. The method of claim 17, wherein the surface of the charge transfer layer is not substantially chemically modified by the plasma treatment.

19. The method of claim 17, wherein the organic charge transfer layer is a polymeric charge transfer layer.

20. The method of claim 17, wherein the surface of the charge transfer layer is at least partially oxidized, but not otherwise substantially chemically modified, by the plasma treatment.

21. The method of claim 17, wherein selectively thermally transferring the transfer element to the substrate occurs without exposure to air after the roughening.

22. The method of claim 17, wherein the transfer element comprises an electrically active layer.
